(19) United States
(12) Patent Application Publication
(10) Pub. No.: US 2025/0384563 A1
(43) Pub. Date: Dec. 18, 2025

(54) Method, an apparatus to generate a 3-dimensional segmentation of cells and a cor-responding program

(71) Applicant: Leica Microsystems CMS GmbH, Wetzlar (DE)

(72) Inventors: Hideki SASAKI, Wetzlar (DE); Hung-Yu CHANG, Wetzlar (DE)

(21) Appl. No.: 18/798,867

(22) Filed: Aug. 9, 2024

Related U.S. Application Data
(60) Provisional application No. 63/658,902, filed on Jun. 12, 2024.

(51) Int. Cl. G06T 7/174; G06T 7/11; G06T 7/187

(52) U.S. Cl. CPC G06T 7/174; G06T 7/11; G06T 7/187; G06T 2200/04; G06T 2207/10056; G06T 2207/30024

(57) ABSTRACT

Provided is a method (100) to generate a 3-dimensional segmentation of cells based on a stack of images taken at different focal planes within a specimen. The method comprises receiving a 2-dimensional vertical gradient map and a 2-dimensional horizontal gradient map for every focal plane (110) and determining a 2-dimensional cell segmentation map (120) for every focal plane based on the vertical gradient map and the horizontal gradient map of the focal plane. The method further comprises merging 2-dimensional cell segmentation maps of neighboring focal planes (130) to generate the 3-dimensional segmentation of the cells.

### FIELD

The present disclosure relates to method to generate a 3-dimensional segmentation of cells based on a stack of images taken at different focal planes within a specimen.

3-dimensional segmentation of cells is a process in computational biology and medical imaging that involves identifying and delineating the boundaries of cells within a three-dimensional (3D) dataset. The applications of 3D cell segmentation are vast. It allows for quantitative analysis by measuring cell volume, shape, and spatial distribution. Moreover, it enables the creation of 3D visualizations of cells, facilitating better understanding and presentation. Automated workflows leveraging 3D cell segmentation enable high-throughput analysis in both research and clinical settings. For example, this technique may be used in biological research to monitor cell morphology, cell division, and cellular interactions in their native environment. In medical diagnostics, tissue samples may be observed to detect abnormalities and aid in the diagnosis of diseases such as cancer. For drug development, the effects of drugs on cells can be monitored in a more realistic 3D context, mimicking in vivo conditions.

Several challenges are associated with 3D cell segmentation. The complexity of cell structures, with their intricate shapes and close packing makes accurate segmentation difficult. Additionally, variability in imaging conditions, such as differences in staining and imaging resolution, can affect segmentation quality. Since cells exhibit diverse shapes, sizes, and textures, it is challenging for algorithms to generalize across different cell types and imaging conditions. Algorithms that perform well under one set of conditions may fail under another.

Processing 3D datasets may also demand significant computational power and memory, particularly for those implementations based on deep learning. Machine learning and deep learning-based methods also depend heavily on large amounts of annotated training data. Creating these annotated datasets is labor-intensive and time-consuming and the performance of the algorithm is heavily dependent on the quality and diversity of the training data. Even if the training data set for a particular application is carefully prepared, generalization is an issue. Models trained on specific datasets may not generalize well to new, unseen data. Many segmentation algorithms still require manual intervention to correct errors or refine results, which can be time-consuming and may introduce variability and subjectivity into the results.

Hence, there is a demand for a robust and effective 3D segmentation solution.

### SUMMARY

Said demand is satisfied by the subject matter defined in the independent claims.

An example relates to a method to generate a 3-dimensional segmentation of cells based on a stack of images taken at different focal planes within a specimen. The method comprises receiving a 2-dimensional vertical gradient map and a 2-dimensional horizontal gradient map for every focal plane and determining a 2-dimensional cell segmentation map for every focal plane based on the vertical gradient map and the horizontal gradient map of said focal plane. The method further comprises merging the 2-dimensional cell segmentation maps of neighboring focal planes to generate the 3-dimensional segmentation of the cells. Generating the 3-dimensional segmentation of the cells by merging already existent 2-dimensional segmentations may increase the processing speed as compared to conventional approaches and additionally or alternatively also achieve better results. Performing 2D segmentation on individual images in a stack and then joining these segmentations in the third dimension may reduce computational complexity. Segmenting 2D slices individually is generally less computationally intensive than directly performing 3D segmentation on the entire volume. This approach can make the segmentation process faster and more manageable, especially for large datasets. Also, the approach is more scalable when dealing with very large datasets. Individual slices can be processed in parallel, distributing the computational load more effectively than attempting to segment the entire 3D volume at once. Another benefit may be simplified algorithm development. Developing and tuning 2D segmentation algorithms may be simpler than creating 3D algorithms. Well-established 2D segmentation techniques and tools can be applied to each slice, potentially reducing the complexity of the segmentation pipeline.

According to an example, merging 2-dimensional cell segmentation maps of neighboring focal planes comprises determining an area of an overlap of a first area associated to a cell in a first cell segmentation map of a focal plane and a second area associated to a cell in a second cell segmentation map of the neighboring focal plane. A ratio between the area of overlap and a sum of the first area and the second area is determined, and the first area and the second area are merged into a 3-dimensional segmentation of a cell if the ratio fulfills a determined criterion. Joining segmentations in the third dimension based on the area of overlap of the 2D segmentations may enhance robustness to noise and artifacts present in individual slices. Overlapping areas are more likely to represent true structures rather than random noise, as true anatomical structures will consistently appear across adjacent slices. By using overlapping regions, the segmentation process may effectively filter out noise and artifacts, resulting in cleaner and more accurate 3D reconstructions.

Joining segmentations based on overlap may simplify post-processing steps. The overlap provides an efficient way to align and merge segments, reducing the need for complex algorithms to resolve inconsistencies between slices.

In some examples, the criterion for the overlap may be fulfilled if the ratio exceeds a determined threshold, resulting in a robust and computationally efficient implementation.

In some examples, merging 2-dimensional cell segmentation maps of neighboring focal planes comprises determining a distance between a first center of a first area associated to a ycell in a first cell segmentation map of a focal plane and a second center of a second area associated to a cell in a second cell segmentation map of the neighboring focal plane, and merging the first area and the second area into a 3-dimensional segmentation of a cell if the distance fulfills a determined criterion.

Using the distance between the center of a first area in a first cell segmentation map and the center of a second area in a second cell segmentation map as a criterion to merge these areas into a 3-dimensional segmentation of a cell results in a simple and efficient computational process. By focusing on the distance between centers, the algorithm can quickly determine whether two areas should be merged. As a result, the segmentation process becomes faster and requires less computational power. Using the distance between centers provides a consistent and objective criterion for merging areas. This approach avoids the subjectivity that might arise from more complex or qualitative merging criteria. It may also be easily adjusted by changing the distance threshold to accommodate variations in cell size and density. This makes the approach versatile and applicable to a wide range of biological samples and experimental setups. For example, the criterion may be fulfilled if the distance is smaller than a determined threshold.

In some examples, determining a 2-dimensional cell segmentation map for every focal plane comprises determining a magnitude map based on a 2-dimensional vertical gradient map and on a 2-dimensional horizontal gradient map, determining a divergence map based on the 2-dimensional vertical gradient map and the 2-dimensional horizontal gradient map. A 2-dimensional vertical gradient map is an image representation that captures the rate of change in pixel intensity values in the vertical direction (up and down) within an image. A pixel within the 2-dimensional vertical gradient map indicates how much the intensity value of the pixel changes compared to its vertical neighbor. Similarly, a 2-dimensional horizontal gradient map is an identical representation in the horizontal direction (left and right). For example, a pixel value f(x, y) within the magnitude map may be determined using the following equation

$$\vert f \vert = \sqrt{{f}_{x}^{2} + {f}_{y}^{2}} ,$$

with fₓ being the value of the pixel in the 2-dimensional vertical gradient map an f_{y} being the value of the pixel in the 2-dimensional horizontal gradient map, and a pixel value within the divergence map may be determined using the following equation

$$f = \frac{\partial {f}_{x}}{dx} + \frac{\partial {f}_{v}}{dy} .$$

A divergence map is a representation that captures the divergence of a vector field within a particular region or space. Divergence measures the magnitude of a source or sink at a given point in a vector field, essentially quantifying how much a vector field spreads out (diverges) or converges at a specific location. Some examples may, therefore, determine a local minimum within the divergence map as a center of a cell with high reliability.

Some examples may comprise combining the magnitude map and the divergence map to determine a confidence map. The confidence map comprises a confidence value for every pixel that indicates whether the pixel belongs to a cell or not.

In some examples, determining a 2-dimensional cell segmentation map for every focal plane comprises combining the 2-dimensional vertical gradient map and a 2-dimensional horizontal gradient map to generate a gradient field map. The gradient field map defines a path from every pixel in the gradient field map to the closest local minimum in the gradient field map. A part of the path is attributed to a segmentation of a cell using a partitioning criterion. Combining a 2-dimensional vertical gradient map and a 2-dimensional horizontal gradient map results in a comprehensive gradient field map that captures the overall changes in pixel intensity in both vertical and horizontal directions. For example, the gradient field map may be derived from the magnitude map f(x, y) giving the magnitude of the gradient at every pixel by also determining the direction of the gradient

$$θ ( x , y ) = arctan ( \frac{{g}_{v} ( x , y )}{{g}_{h} ( x , y )} ) .$$

Some aspects of the present disclosure relate to an apparatus for generating a 3-dimensional segmentation of cells based on a stack of images taken at different focal planes within the specimen. The apparatus comprises an input interface configured to receive a 2-dimensional image for every focal plane. The apparatus further comprises circuitry configured to determine a 2-dimensional vertical gradient map and a 2-dimensional horizontal gradient map for every 2-dimensional image, determine a 2-dimensional cell segmentation map for every focal plane based on the vertical gradient map and the horizontal gradient map of the focal plane, and merge 2-dimensional cell segmentation maps of neighboring focal planes to generate the 3-dimensional segmentation of the cells.

In some examples, the circuitry may comprise first sub-circuitry configured to determine the 2-dimensional vertical gradient map and the 2-dimensional horizontal gradient map, and second sub-circuitry configured to determine the 2-dimensional cell segmentation map and merge the 2-dimensional cell segmentation maps of neighboring focal planes. Splitting the different computations amongst different sub-circuits may allow to choose circuitry specifically suitable for the individual task, resulting in a fast and reliable implementation. According to an example, the first sub-circuitry may be part of a Graphics Processing Unit, GPU, and the second sub-circuitry may be part of a Central Processing Unit, CPU. The computationally challenging and parallelizable tasks of computing the gradient maps may hence be performed by GPUs that are highly appropriate for this task while the tasks that may be subject to change (and less complex) may be implemented on a CPU which is a General-Purpose Computing Processor.

For similar reasons, the second sub-circuitry may further be configured to determine an area of a 2-dimensional overlap of a first area associated to a cell in a cell segmentation map and a second area associated to a cell in the neighboring cell segmentation map. The second sub-circuitry may further determine a ratio between the area of overlap and a sum of the first area and the second area and merge the first area and the second area into a 3-dimensional segmentation of a cell if the ratio exceeds a determined threshold. In some examples, the second sub-circuitry may further be configured to determine a distance between a first center (nucleus) of a first area associated to a cell in a cell segmentation map and a second center of a second area associated to a cell in the neighboring cell segmentation map. Optionally, the second sub-circuitry may merge the first area and the second area into a 3-dimensional segmentation of a cell if the distance may be smaller than a determined threshold.

### BRIEF DESCRIPTION OF THE FIGURES

Some examples of apparatuses and/or methods will be described in the following by way of example only, and with reference to the accompanying figures, in which

FIG. 1 schematically illustrates a flowchart of an embodiment of a method to generate a 3-dimensional segmentation of cells;

FIG. 2 illustrates a first implementation of merging 2-dimensional cell segmentation maps;

FIG. 3 illustrates a second implementation of merging 2-dimensional cell segmentation maps;

FIG. 4 illustrates a first implementation of determining a 2-dimensional cell segmentation map for every focal plane based on the vertical gradient map and the horizontal gradient map;

FIG. 5 illustrates a second implementation of determining a 2-dimensional cell segmentation map for every focal plane based on the vertical gradient map and the horizontal gradient map;

FIG. 6 illustrates an embodiment of an apparatus for generating a 3-dimensional segmentation of cells;

FIG. 7 illustrates an example for splitting the computations of the apparatus of FIG. 6 amongst different sub-circuitries;

FIG. 8 illustrates an example for generating a 2-dimensional vertical gradient map and a 2-dimensional horizontal gradient map for every focal plane within a specimen; and

FIG. 9 illustrates a microscope and a computing system.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

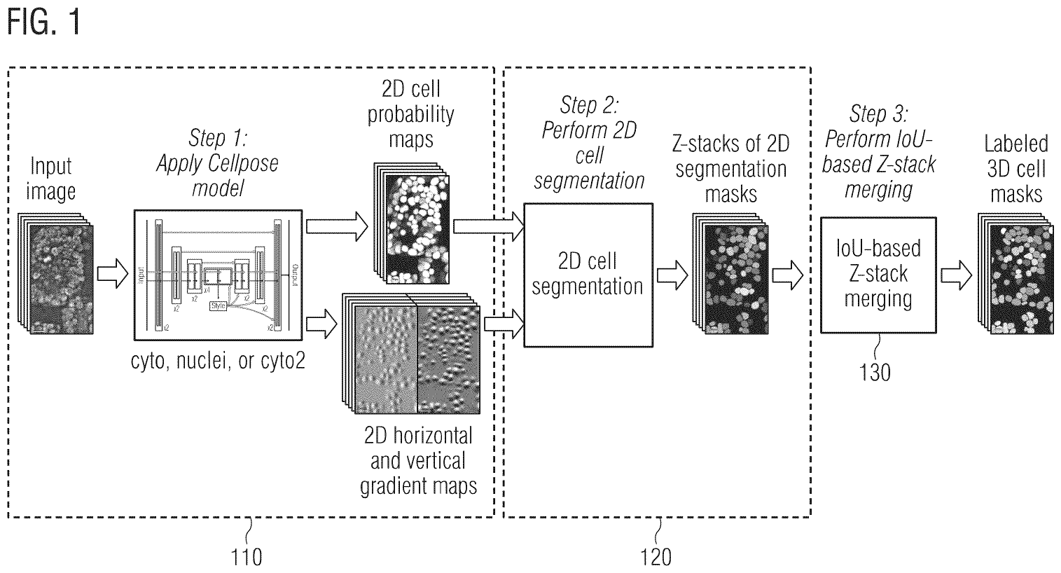

FIG. 1 illustrates an embodiment of a method to generate a 3-dimensional segmentation of cells. The steps of the method are represented by rectangular boxes that are partly supplemented with additional elements, representing optional method steps.

The method comprises receiving 110 a 2-dimensional vertical gradient map 112b and a 2-dimensional horizontal gradient map 112a for every focal plane. A focal plane in microscopy refers to the specific plane within a sample that is in sharp focus at any given time. It is the layer where the microscope's optics are adjusted to produce the clearest image, allowing for the detailed observation of structures within that plane. The focal plane is important for accurately capturing the details of microscopic samples, as it determines which part of the sample is being observed with the highest clarity. A z-stack is a series of images taken at different focal planes along the z-axis, which is the axis perpendicular to the plane of the sample. By capturing multiple images at various depths, a z-stack provides a three-dimensional representation of the sample. This technique can visualize the internal structure of thick specimens, allowing researchers to analyze and reconstruct the 3D organization of cells, tissues, and other microscopic entities. By combining these images, one may create a detailed volumetric representation of the sample.

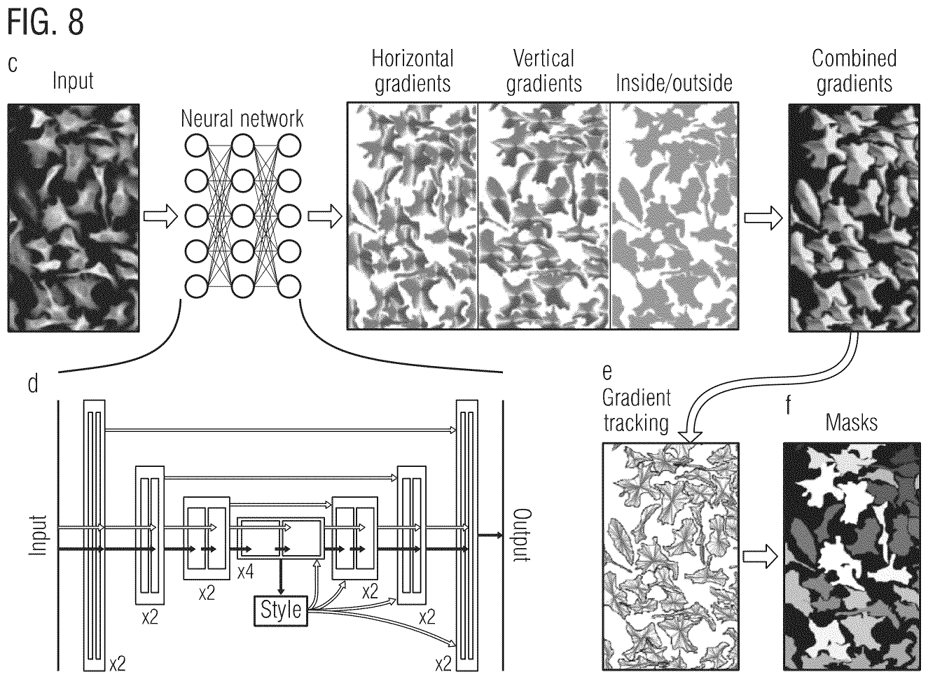

An example as to how to the 2-dimensional vertical gradient maps and the 2-dimensional horizontal gradient maps may be created according to a conventional approach (subsequently called Cellpose) will be illustrated in FIG. 8. For the embodiment described in FIG. 1, arbitrary ways to generate the gradient maps may be used before they are processed by the method illustrated in FIG. 1.

The method 100 further comprises determining 120 a 2-dimensional cell segmentation map 122 for every focal plane of the z-stack based on the vertical gradient map 112b and the horizontal gradient map 112a of the focal plane.

The method further comprises merging 130 the 2-dimensional cell segmentation maps 122 of neighboring focal planes to generate the 3-dimensional segmentation of the cells 140.

Performing 2D segmentation on individual images in a stack and then joining these segmentations in the third dimension as illustrated in FIG. 1 may, for example, reduce computational complexity.

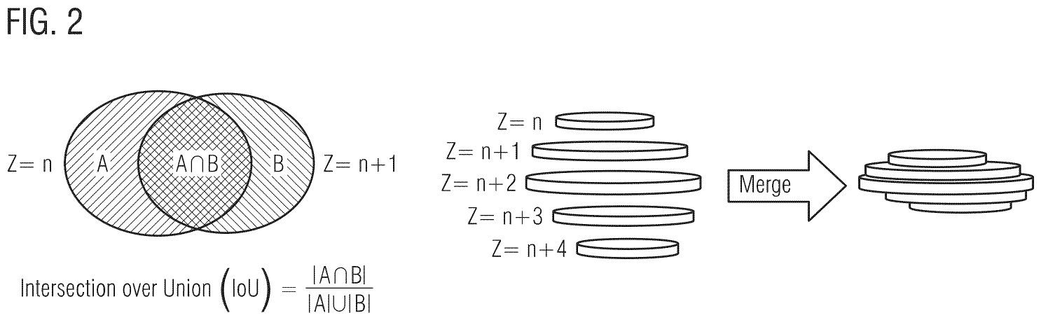

FIG. 2 illustrates a first implementation of merging 2-dimensional cell segmentation maps 120. The left illustration of FIG. 2 illustrates a projection of areas associated to cells of neighboring focal planes by the 2-dimensional segmentation along the z-direction, which is perpendicular to the area of the 2-dimensional cell segmentation maps 120. The first implementation comprises determining an area of an overlap 210 of a first area associated 220 to a cell in a first cell segmentation map 222 of a focal plane (Z=n) and a second area 230 associated to a cell in a second cell segmentation map 232 of the neighboring focal plane (Z=n+1). The method further comprises determining a ratio between the area of overlap 210 and a sum of the first area 220 and the second area 230 as illustrated in FIG. 2. The first and second areas are merged into a 3-dimensional segmentation of a cell 240 if the ratio (IoU) exceeds a determined threshold. As illustrated in FIG. 2, multiple areas of neighboring focal planes Z=n, . . . , n+4 can be merged into a single 3-dimensional segmentation of a cell.

In other words, 2D masks in adjacent Z-stacks are merged if the intersection over union (IoU) is greater than the specified threshold and a specific implementation of the method may be summarized as follows. A specific Cellpose model (e.g. cyto, nuclei, or cyto2 can be used to generate a horizontal gradient map, a vertical gradient map, and optionally a cell probability map for each Z-stack (focal plane). 2-dimensional cell segmentation is performed using two or three of those maps to generate segmentation masks for individual Z-stacks. Intersection over union (IoU)-based Z-stack merging is used to reconstruct cell masks in 3D.

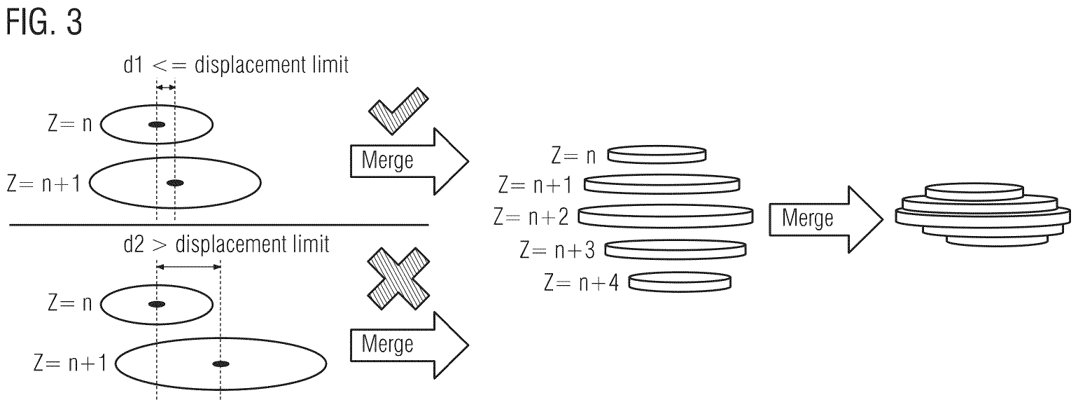

FIG. 3 illustrates a second implementation of merging 2-dimensional cell segmentation maps.

The second implementation comprises determining a distance 310 between a first center 320 of a first area (322) associated to a cell in a first cell segmentation map of a focal plane (Z=n) and a second center 330 of a second area 332 associated to a cell in a second cell segmentation map of the neighboring focal plane (Z=n+1). In the second implementation, the first area and the second area are merged into a 3-dimensional segmentation of a cell 340 if the distance fulfills a determined criterion.

The criterion is fulfilled, if the distance is smaller than a determined threshold.

The method using the second implementation may be summarized in that 2D masks in adjacent Z-stacks are merged if the displacement between two mask centers is less than a specified displacement limit.

By focusing on the distance between centers, the algorithm can quickly determine whether two areas should be merged. As a result, the segmentation process becomes faster and requires less computational power. Using the distance between centers provides a consistent and objective criterion for merging areas. Furthermore, the determined threshold can be easily adapted to different cell samples, if necessary, without changing the computations and hence without the need for further training and without causing an additional latency.

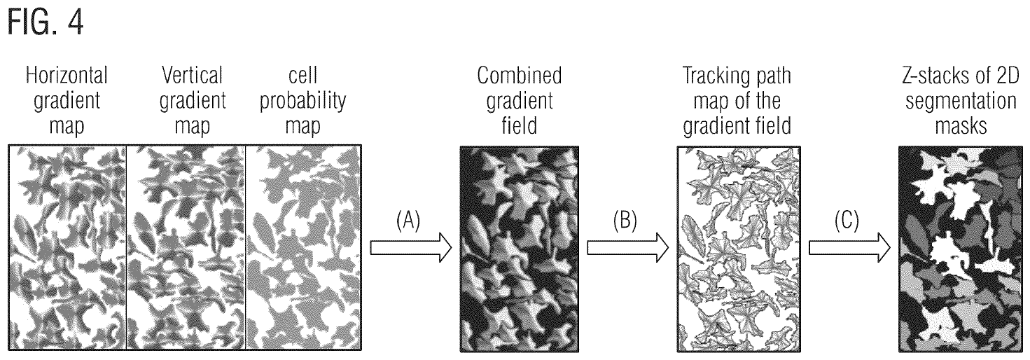

FIG. 4 illustrates a first implementation of determining a 2-dimensional cell segmentation map for every focal plane based on the vertical gradient map 420 and the horizontal gradient map 410.

The implementation comprises combining the 2-dimensional vertical gradient map 420 and the 2-dimensional horizontal gradient map 410 to generate a gradient field map 430. The method further comprises defining a path from every pixel in the gradient field map 430 to the closest local minimum in the gradient field map, as illustrated by means of illustration 440 shoeing a tracking path map. A part of the path can be attributed to a segmentation of a cell using a partitioning criterion. For example, a cutoff value may be defined such that only pixels along the path that have values exceeding the cutoff value are assigned to cells.

The implementation of FIG. 4 may also be summarized as combining the horizontal and vertical gradient maps 410, 420 to generate the gradient field map 430, masked by a thresholded cell probability map 425. Subsequently, gradient tracking (trace to the local basin) is performed from each pixel of the gradient field map 430 within the masks to generate the accumulated tracking path map 440. The accumulated tracking path map 440 is partitioned to generate individual cell masks.

Optionally, 1D median filtering along the Z-axis may be applied to the horizontal and vertical gradient maps 410, 420 as well as to the optional cell probability map 425 to make them more consistent along Z.

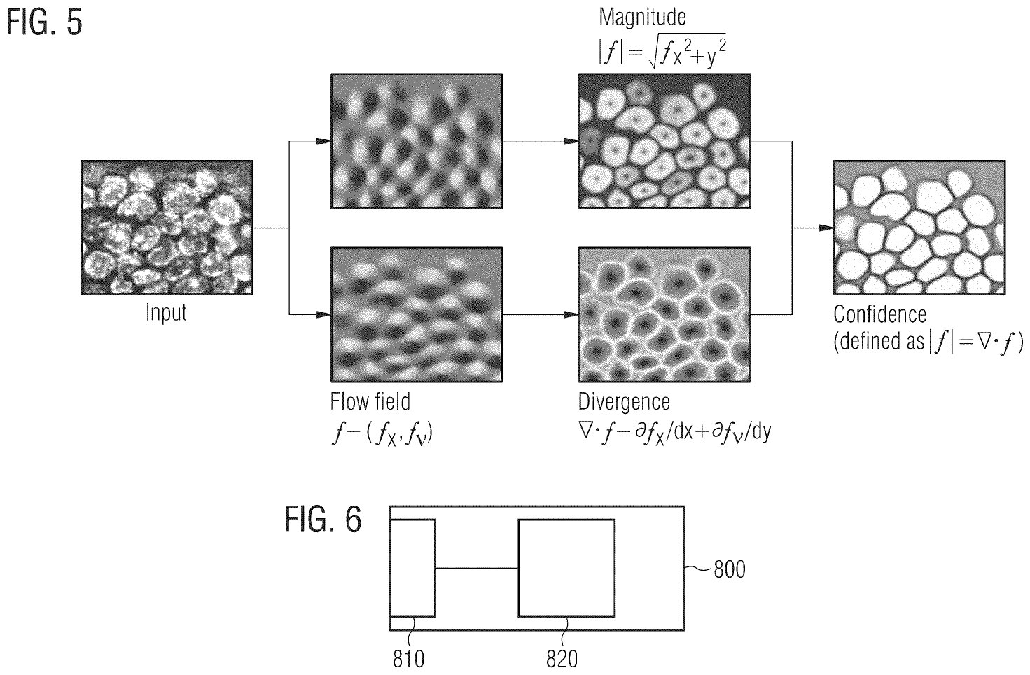

FIG. 5 illustrates a second implementation of determining a 2-dimensional cell segmentation map for every focal plane based on the vertical gradient map 520 and the horizontal gradient map 510.

The implementation comprises determining a magnitude map 540 and a divergence map 530 based on the 2-dimensional vertical gradient map 520 and on the 2-dimensional horizontal gradient map 510.

A pixel value f(x, y) within the magnitude map 540 is determined using the following equation

$$\vert f \vert = \sqrt{{f}_{x}^{2} + {f}_{y}^{2}} ,$$

with fₓ being the value of the pixel in the 2-dimensional vertical gradient map 520 an f_{y} being the value of the pixel in the 2-dimensional horizontal gradient map 510, and a pixel value within the divergence map 530 is determined using the following equation

$$f = \frac{\partial {f}_{x}}{dx} + \frac{\partial {f}_{v}}{dy} .$$

A local minimum within the divergence map indicates a center of a cell. The magnitude map 540 and the divergence map 530 are combined to determine a confidence map 550. In the confidence map, a value of a pixel indicates a probability that the pixel belongs to a cell or not.

The implementation illustrated in FIG. 5 may be summarized as combining horizontal and vertical gradient maps 510, 520 to generate the magnitude image 540 and divergence image 530 and combining the magnitude image 540 and divergence image 530 to generate a confidence image 550. The confidence image (confidence map) 550 may show better separation between cells than the original probability map of a conventional approach. The center of each cell may be reliably identified as a sharp local minimum in the divergence of the flow.

One may optionally further use the identified centers of the cells as seeds for a watershed algorithm to create a 2D segmentation mask for each Z-frame.

From a conceptual view, the implementation may also be summarized as applying a Cellpose model (cyto, nuclei, or cyto2) to generate a horizontal gradient map and a vertical gradient map for each Z-stack. Flow-based 2D cell segmentation is applied to generate segmentation masks for individual Z-stacks. Afterwards, Z-Stack merging is performed to reconstruct cell masks in 3D using mask center displacement.

This approach may be much faster than gradient tracking in the original Cellpose workflow or in other conventional solutions.

FIG. 6 illustrates an embodiment of an apparatus 800 for generating a 3-dimensional segmentation of cells based on a stack of images taken at different focal planes within the specimen. The apparatus comprises an input interface 810 configured to receive a 2-dimensional image for every focal plane. The images may, for example, be received from a microscope directly or via a network. Likewise, the images may also be read from a storage device.

The apparatus 800 further comprises circuitry 820 configured to determine a 2-dimensional vertical gradient map and a 2-dimensional horizontal gradient map for every 2-dimensional image. Further, circuitry 820 determines a 2-dimensional cell segmentation map for every focal plane based on the vertical gradient map and the horizontal gradient map of the focal plane. The circuitry is further configured to merge the 2-dimensional cell segmentation maps of neighboring focal planes to generate the 3-dimensional segmentation of the cells.

The apparatus 800 may also be characterized in that it is configured to perform any of the methods described in the previous paragraphs.

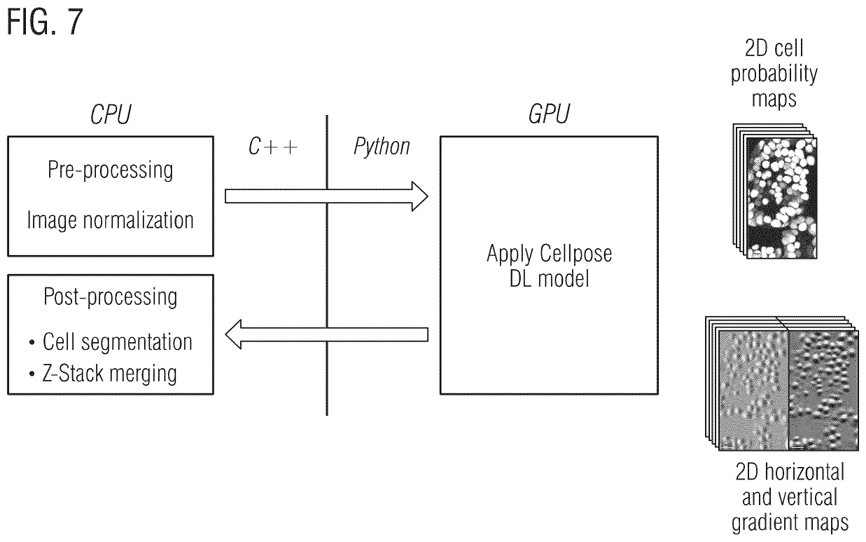

FIG. 7 illustrates an example for splitting the computations of the apparatus of FIG. 6 amongst different sub-circuitries.

According to this implementation, circuitry 820 comprises first sub-circuitry 822 configured to determine the 2-dimensional vertical gradient map and the 2-dimensional horizontal gradient map. Second sub-circuitry 824 is configured to determine the 2-dimensional cell segmentation map and to merge the 2-dimensional cell segmentation maps of neighboring focal planes. In the implementation illustrated in FIG. 7, the first sub-circuitry 822 is part of a Graphics Processing Unit, GPU, and the second sub-circuitry 824 is part of a Central Processing Unit, CPU.

According to some implementations, the processing using the first sub-circuitry 822 and the second sub-circuitry 824 is performed in parallel (simultaneously) to enhance the speed of the segmentation. The computationally challenging and parallelizable tasks of computing the gradient maps may hence be performed by GPUs that are highly appropriate for this task while the tasks that may be subject to change while not being so demanding computationally may be implemented on a CPU which is a General-Purpose Computing Processor.

In other words, pre-processing and post-processing is executed on a CPU (programmed, for example, in C++). The time-consuming Cellpose model is executed on one or more GPUs (e.g. implemented in Python). Tasks on CPU and GPU can be parallelized to take full advantage of the computing power on both, CPU and GPU.

FIG. 8 illustrates an example for generating a 2-dimensional vertical gradient map 820 and a 2-dimensional horizontal gradient map 810 for every focal plane within a specimen based on the Cellpose approach as well as for further processing steps following the Cellpose implementation.

A trained neural network 830 is used to predict the vertical gradient map 820 and the 2-dimensional horizontal gradient map, as well as a probability map 840 indicating whether a pixel belongs to any cell. The three predicted maps 820, 830, and 850 are combined into a gradient vector field 860.

FIG. 8 also illustrates some details of a neural network 830 that may be used. The neural network 830 contains a backbone U-Net to downsample and then upsample the feature maps, with skip connections between layers of the same size and global skip connections from the image styles, computed at the lowest resolution, to all successive computations. The predicted gradient vector fields are used to construct a dynamical system 870 with fixed points whose basins of attraction represent the predicted masks. In other words, every pixel ‘tracks the gradients’ toward their eventual fixed point. In the segmentation mask image 880, all the pixels that converge to the same fixed point are assigned to the same mask (image).

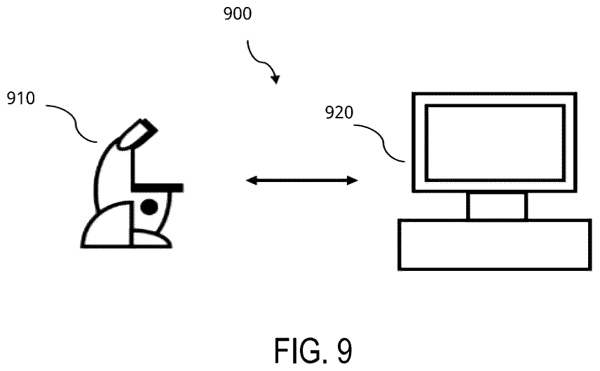

Some embodiments relate to a microscope comprising a system as described in connection with one or more of the FIGS. 1 to 9. Alternatively, a microscope may be part of or connected to a system as described in connection with one or more of the FIGS. 1 to 9. FIG. 9 shows a schematic illustration of a system 900 configured to perform a method described herein. The system 900 comprises a microscope 910 and a computer system 920. The microscope 910 is configured to take images and is connected to the computer system 920. The computer system 920 is configured to execute at least a part of a method described herein. The computer system 920 may be configured to execute a machine learning algorithm. The computer system 920 and microscope 910 may be separate entities but can also be integrated together in one common housing. The computer system 920 may be part of a central processing system of the microscope 910 and/or the computer system 920 may be part of a subcomponent of the microscope 910, such as a sensor, an actor, a camera or an illumination unit, etc. of the microscope 910.

The computer system 920 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 920 may comprise any circuit or combination of circuits. In one embodiment, the computer system 920 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 920 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 920 may include one or more storage devices, which may include one or more memory elements suitable to the particular application, such as a main memory in the form of random-access memory (RAM), one or more hard drives, and/or one or more drives that handle removable media such as compact disks (CD), flash memory cards, digital video disk (DVD), and the like. The computer system 920 may also include a display device, one or more speakers, and a keyboard and/or controller, which can include a mouse, trackball, touch screen, voice-recognition device, or any other device that permits a system user to input information into and receive information from the computer system 920.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all the functionalities of the methods described herein. In some embodiments, a field programmable gate array may cooperate with a microprocessor to perform one of the methods described herein. Generally, the methods are preferably performed by any hardware apparatus.

What is claimed is:

1. A method (100) to generate a 3-dimensional segmentation of cells based on a stack of images taken at different focal planes within a specimen, the method comprising:
receiving a 2-dimensional vertical gradient map and a 2-dimensional horizontal gradient map for every focal plane (110);
determining a 2-dimensional cell segmentation map (120) for every focal plane based on the vertical gradient map and the horizontal gradient map of the focal plane; and
merging 2-dimensional cell segmentation maps of neighboring focal planes (130) to generate the 3-dimensional segmentation of the cells.

2. The method of claim 1, wherein merging 2-dimensional cell segmentation maps of neighboring focal planes comprises:
determining an area of an overlap of a first area associated to a cell in a first cell segmentation map of a focal plane and a second area associated to a cell in a second cell segmentation map of the neighboring focal plane;
determining a ratio between the area of overlap and a sum of the first area and the second area; and
merging the first area and the second area into a 3-dimensional segmentation of a cell if the ratio fulfills a determined criterion.

3. The method of claim 2, wherein the criterion is fulfilled if the ratio exceeds a determined threshold.

4. The method of claim 1, wherein merging 2-dimensional cell segmentation maps of neighboring focal planes comprises:
determining a distance between a first center of a first area associated to a cell in a first cell segmentation map of a focal plane and a second center of a second area associated to a cell in a second cell segmentation map of the neighboring focal plane; and
merging the first area and the second area into a 3-dimensional segmentation of a cell if the distance fulfills a determined criterion.

5. The method of claim 4, wherein the criterion is fulfilled if the distance is smaller than a determined threshold.

6. The method of claim 1, wherein determining a 2-dimensional cell segmentation map for every focal plane comprises:
combining the 2-dimensional vertical gradient map and a 2-dimensional horizontal gradient map to generate a gradient field map;
defining a path from every pixel in the gradient field map to the closest local minimum in the gradient field map; and
attributing a part of the path to a segmentation of a cell using a partitioning criterion.

7. The method of claims 1, wherein determining a 2-dimensional cell segmentation map for every focal plane comprises:
determining a magnitude map based on the 2-dimensional vertical gradient map and on the 2-dimensional horizontal gradient map;
determining a divergence map based on the 2-dimensional vertical gradient map and the 2-dimensional horizontal gradient map.

8. The method of claim 7, further comprising:
combining the magnitude map and the divergence map to determine a confidence map.

9. The method of claim 7, further comprising:
determining a local minimum within the divergence map as a center of a cell.

10. The method of claim 7, wherein
a pixel value within the magnitude map is determined using the following equation:
$$\vert f \vert = \sqrt{{f}_{x}^{2} + {f}_{y}^{2}} ,$$
with fₓ being the value of the pixel in the 2-dimensional vertical gradient map an f_{y} being the value of the pixel in the 2-dimensional horizontal gradient map; and
a pixel value within the magnitude map is determined using the following equation:
$$f = \frac{\partial {f}_{x}}{dx} + \partial {f}_{v} / dy .$$

11. An apparatus (800) for generating a 3-dimensional segmentation of cells based on a stack of images taken at different focal planes within the specimen, the apparatus comprising:
an input interface (810) configured to receive a 2-dimensional image for every focal plane; and
circuitry (820) configured to:
determine a 2-dimensional vertical gradient map and a 2-dimensional horizontal gradient map for every 2-dimensional image;
determine a 2-dimensional cell segmentation map for every focal plane based on the vertical gradient map and the horizontal gradient map of the focal plane; and
merge 2-dimensional cell segmentation maps of neighboring focal planes to generate the 3-dimensional segmentation of the cells.

12. The apparatus of claim 11, wherein the circuitry comprises first sub-circuitry configured to determine the 2-dimensional vertical gradient map and the 2-dimensional horizontal gradient map; and
second sub-circuitry configured to:
determine the 2-dimensional cell segmentation map; and
merge the 2-dimensional cell segmentation maps of neighboring focal planes.

13. The apparatus of claim 12, wherein the
first sub-circuitry is part of a Graphics Processing Unit, GPU, and
the second sub-circuitry is part of a Central Processing Unit, CPU.

14. The apparatus of claim 12, wherein the second sub-circuitry is configured to
determine an area of a 2-dimensional overlap of a first area associated to a cell in a cell segmentation map and a second area associated to a cell in the neighboring cell segmenta-tion map;
determine a ratio between the area of overlap and a sum of the first area and the second area; and
merge the first area and the second area into a 3-dimensional segmentation of a cell if the ratio exceeds a deter-mined threshold.

15. The apparatus of claims 12,
wherein the second sub-circuitry is configured to determine a distance between a first center (nucleus) of a first area associated to a cell in a cell segmentation map and a second center of a second area associated to a cell in the neighboring cell segmentation map; and
merging the first area and the second area into a 3-dimensional segmentation of a cell if the distance is smaller than a determined threshold.

16. A computer readable storage medium having stored thereon program code, the program code causing execution of a method according to claim 1 if the program code is executed by a computing system.
